(19) United States
(12) Patent Application Publication
(10) Pub. No.: US 2007/0061178 A1
(43) Pub. Date: Mar. 15, 2007

(54) BUSINESS DEVELOPMENT SYSTEM AND METHODOLOGY

(76) Inventor: Mark Wilson, Rochester, NY (US)

Correspondence Address: JAECKLE FLEISCHMANN & MUGEL, LLP, 190 Linden Oaks, ROCHESTER, NY, 14625-2812, US

(21) Appl. No.: 11/531,126

(22) Filed: Sep. 12, 2006

Related U.S. Application Data
(60) Provisional application No. 60/716,723, filed on Sep. 13, 2005.

(51) Int. Cl. G06F 17/50

(52) U.S. Cl. 705/7

(57) ABSTRACT

A very early stage business development system and method is implemented within an abbreviated period of time to produce an objective decision point of whether or not to proceed to the next stage of business formation.

### CROSS-REFERENCE TO RELATED APPLICATIONS

This application claims priority to U.S. provisional patent application 60/716,723, entitled, “Business Development System and Methodology” filed Sep. 13, 2005, which is hereby officially incorporated by reference in its entirety.

### BACKGROUND OF THE INVENTION

This invention relates in general to a very early-stage business development model which may be applied to an embryonic idea or concept and implemented within an abbreviated period of time to produce an objective decision point of whether or not to proceed to the next stage of business formation. In particular, the business development model of the present invention integrates multiple tools and strategies over a short, defined period of time to give an entrepreneur objective criteria to justify additional financing and development of a business that is anchored by the idea or concept. The tools utilized by the present invention include a team leader, manager, or mentor to administer the process; local government and/or university expertise to integrate local or regional economic concerns into the business planning; human resource components to identify key employee positions at all levels of the business, including executive, management and labor; financial expertise to evaluate the feasibility of procuring start-up funding or financial planning to actualize the idea or concept; and cross-industry expertise to bring ideas from other businesses and business modalities into the business from its inception. More specifically, this invention accumulates and organizes these and other business consulting tools in a unique and previously-unknown manner within the framework of a defined sequence of steps and over a limited period of time to accelerate the business decision process for a pre-startup company.

It is axiomatic that the majority of individuals who desire to start a business do so in a haphazard and random fashion, with most decisions being made on an intuitive basis. Notwithstanding the inherent risks of starting any business, even the most critical startup decisions, including the core decision of actually proceeding with the business startup itself, are frequently made at the “gut” level. Entrepreneurs become so enamored with their business ideas that they frequently ignore objective criteria and clear factual information, and rely instead on their own sense of wonder and excitement with a business idea to generate the initial momentum for the startup. While the entrepreneur's excitement and personal investment in a business are critical components in the relative success of the startup, objective and external factors can be equally important. Among those factors are the availability of financial, intellectual, and labor resources to add substance to and grow the entrepreneur's idea. Some resources may be readily available to the entrepreneur, yet because of the crush of the responsibilities that the entrepreneur assumes when he or she begins the new business, those resources may go untapped. Further, the entrepreneur's own parochial attitude toward his business idea may blind him to the true value of those resources.

Many services are available at both formal and informal levels to assist the entrepreneur to evaluate his business idea and to marshal the necessary resources to bring that business idea to fruition, yet few, if any, aggregate the full range of resources for the entrepreneur. For example, universities and government agencies may offer a plethora of research and technology resources to streamline product or service development or to enhance technical capabilities of an idea. Consultants and consulting groups are always available to assist the entrepreneur to develop mission statements and to narrow the focus of his business, for example, to key products or services and strategic markets. Yet very few of these resources will offer services pro bono or for at-risk compensation, leaving it to the entrepreneur to work on their own. There are a plethora of self-help books on the topic of starting your own business. Yet there is no way for the entrepreneur to know which books to read and which sections will be most applicable. Venture capital groups and angel investors rarely get involved in ideas that are still at the early concept stage. Hence, there currently exists a gap in services at the very first stages of any business idea which point the entrepreneur in the right direction from the outset, or even to give the entrepreneur a sense that his idea and business have true marketability and merit or that there is no practical way to profitably implement his idea.

More specifically, for example, universities and research labs generally maintain a portfolio of patented technology which does little more than sit in a file drawer and gather dust. Consulting groups can be retained to evaluate that technology for licensing and development potential, all at significant cost to the technology owners, but this process frequently excludes the very inventors and developers of those technology resources, and more significantly it provides no mechanism for commercializing the technology after it had been assessed. Those that have the most passion required to move an idea forward, often don't have a way to participate. As a result, potentially valuable technology will remain unused. Further, already-successful businesses pay lip service to mentoring new companies, and may have, for example, a business development division that seeks new ideas for commercialization. Yet few of those businesses provide the individuals that can facilitate an early business idea analysis. Even where individual assistance is available, the time limitations of that assistance will significantly reduce its value. Even in established companies with new product development processes, often people are not allowed the lime to progress the new idea. Conversely, and just as much a problem, intrapreneurs and entrepreneurs alike, spend too much time on certain aspects of the idea with other priority aspects being ignored. Many teams “fall in love” with a certain aspect of a new idea without diligently deciding if the idea should be pursued.

The most critical and difficult aspect of a business start-up, namely, its financial resources, is often the most haphazardly addressed. If the entrepreneur is unable to finance the startup phase out of his own resources, he will generally turn to venture capital groups or angel funds or grants. Because most venture funds specialize in businesses that have some track record, the entrepreneur more frequently is forced to rely on funding from friends and family members. With rare exceptions, friend- and family-funding creates its own stresses and difficulties without providing any accompanying expertise to maximize its value to the entrepreneur.

There are virtually no services that will force an entrepreneur to face the critical question of whether or not to pursue his business idea. The entrepreneur who seeks outside assistance has generally already committed to the idea without considering the results, conclusions and recommendations that might otherwise come out of the available tools and resources. Moreover, the consulting groups and funds that assist the entrepreneur at this level will have a vested interest in seeing the entrepreneur take the next step to commence the business, as their own consulting businesses will rely on the entrepreneur's business for revenues. When this fact is considered in view of the limiting piecemeal approach presented by the available business tools, the entrepreneur is faced with a system that is designed more to address mistakes, errors and problems after they've already occurred and have hampered the potential of a new business. In reality, the entrepreneur has a greater need for a methodology that will aggregate all of the available tools long before those mistakes, errors and problems occur. Given that the entrepreneur will want to move as quickly as is possible, that methodology will need to be swift and efficient, and will have to generate a rapid response for the entrepreneur's early consideration.

### SUMMARY OF A PREFERRED EMBODIMENT OF THE DISCLOSURE

To overcome the limitations in the prior art described above, and to overcome other limitations that will become apparent upon reading and understanding the present specification, an embodiment of the present invention discloses a methodology for aggregating existing business evaluation and development tools within the framework of a defined structure and period of time to produce not only an objective evaluation of whether or not an entrepreneur should proceed with a new business idea, but also a ready accumulation of resources that will add substance to the idea to allow the entrepreneur to rapidly develop business momentum.

In accordance with the present invention, a process is described that includes a mechanism for assessing and evaluating available technologies; for aligning a pre-qualified business mentor with a business entrepreneur, where the mentor devotes a number of hours to assisting the entrepreneur in exchange for certain compensation; for marshaling community business resources and contractors to enhance the development of a business idea; for identifying and matching employee resources with the needs of the new business, and structuring early employee-team meetings to facilitate early business activities; and for identifying financial resources to capitalize the business start-up. Also, this process helps the inventor answer whether he is the correct person to take the idea forward and/or how to form the right team around the idea. All of the foregoing activities are administered in a defined location within the framework of unique workshops and seminars to allow rapid knowledge transfer to and mentoring of the entrepreneur. The end result is one of two paths: an objective recommendation that the entrepreneur not proceed with the business; or a conclusion that the business idea is viable, along with a relatively detailed structure of what to do next.

### DETAILED DESCRIPTION

The following description is of the preferred embodiment of the present invention. It is to be understood that other embodiments may be utilized as structural changes may be made without departing from the scope of the present invention. As this methodology may be described without reference to drawings, no drawings are included herewith.

The methodology of the present invention may be described in terms of a black box. The basic inputs into the black box are the entrepreneur's idea or concept that will form the basis of a new business, and the entrepreneur and his partners, or team, that may form the business that comes out of the black box. The black box itself aggregates a workshop facilitator to administrate the entire process, startup mentors who assist in evaluating and refining the idea, executive talent to manage the business that may evolve from the black box, financial expertise and resources to confirm that the idea may be developed into a positive return-on-investment business, and professional intellectual, university, and expert advice to fill in any gaps left by the other operators in the black box. The entire process preferably is designed to be completed within a thirty—to forty-hour period, and to conclude with either a rough draft of a viable business plan with content around core topics, or a recommendation that the idea not be pursued further at this time. The period of time in which the process is completed can vary. The thirty—to forty-hour period need not be continuous and can be comprised of two eight-hour working sessions a week apart with the remainder of the time being spent between the two working sessions with the team members working independently, together or in subsets to resolve or flesh out issues raised in the first working session, for example.

It is beneficial to the process if several, preferably about 6, teams go through the process simultaneously. Not only does this allow the workshop facilitator to make efficient use of his time, but a synergy is often created between the teams and the presence of other teams-even though confidential details and break-out sessions are not shared-provides a healthy competition for teams to take their assignments diligently and generate serious results. The business process methodology of the present invention is produced by a consulting administrator who first evaluates prospective entrepreneurial teams and ideas that apply to participate in the process. Unlike existing business development workshops, all members of the entrepreneurial teams that comprise the input into the present methodology are required to commit to the process at its onset and to confirm their ability to participate in the entire thirty- to forty-hour window that encompasses it. The workshop facilitator assigns the team to a location that is separate and apart from their regular working environment. An ideal location will include a large communal workspace with areas for separate meetings and role-playing situations. As this process is applicable and repeatable with any number of entrepreneurial teams and business ideas, dedicated meeting spaces can be built to accommodate the process.

Each team includes a proven startup mentor, who will generally be a successful entrepreneur or other business leader. The startup mentor will participate with the team members throughout the entire process. Optionally, to create a greater incentive for participation by mentors, the startup mentor can receive a fee for his services, which can generally be accounted for by the workshop sponsors or in the business startup costs.

Optionally, each team can include one or more independent contractors, who are generally regional business leaders from the geographic area in which the entrepreneur proposes to locate his business. The contractors can also receive fees for their services. The qualifications and expertise provided by the contractors will generally be a function of the nature of the idea or concept that forms the business. For example, if the idea is specific to the hospitality industry, the independent contractors will likely be retained from regional hotels, restaurants, and entertainment venues. For manufacturing, the contractors will have experience in raw materials, labor, and manufacturing equipment engineering.

The facilitator also can connect the team with potential financing sources, legal advisors, marketing professionals and other valuable resources, who can evaluate and refine the business idea to better attract startup financing. The facilitator preferably maintains a proven resource pool that specializes in very early stage assistance and mentoring, as most professional finance entities, including traditional venture capital sources and banks, lawyers and marketing professionals focus more on businesses that have been in business for a period of time. Finally, the facilitator needs to determine what holes, if any, are left in the talent pool that is accumulated to evaluate the startup business and idea. Those holes can be filled with local university specialties and related expertise. Not all of the necessary resources, executives and professionals need to be on the team for the purpose of the process. The team can be comprised of a subset of these individuals and the process itself will identify what further talent and individuals are needed to start the proposed business. The most important individuals to be on the team and participate in the process are the entrepreneur/inventor and the mentor. In addition to the resources and professionals previously mentioned as potential team members, it may also be beneficial to include students on the team, such as business or marketing students or a student studying the scientific area from which the inventive concept sprung.

Over the course of the thirty- to forty-hour methodology time period, the team meets and presents its answer to each component, participates in traditional business development exercises, and challenges its preconceptions of the strengths and weaknesses of the idea. The format rejects lengthy lectures from the mentor and other talent that is brought in to work with the team. Rather, the team devotes most of its collective energy, without many distractions, to the business idea itself. Implementing this process in a dedicated location away from traditional business distractions, including disruptive telephone calls and email interruptions, further facilitates the speed of the process. The methodology of the present invention includes little classroom or lecture components. Rather, it implements all of its business evaluation components through hands-on evaluation that is directed by the individuals who are brought in to be the operators in the black box.

At the end of the defined time period, the team will have one of two conclusions at its disposal, namely, either a determination that the idea has too many early indications of failure or challenge to proceed, or a business concept that provides an objective, concrete road map for the first six to twelve months of the business's operations. The road map preferably includes specific identification of employees from the executive, level through administration and labor; potential capital structures and financial projections; supplier and raw material sources; and marketing and sales possibilities. Non-working or ineffective aspects of the idea will have been identified and rejected. Most importantly, the idea itself will have been enhanced or thickened with new technologies and resources. The entrepreneurial team that participates in this process will have eliminated the vast majority of errors and problems that are typically faced by businesses in their conceptual phases and shortly after business commences, thus giving that team a significant advantage in getting started with actual business planning and formation.

In one embodiment of the invention, the eight-hour working sessions are divided up into ten modules. Each module begins with a brief lecture, approximately ten minutes long. The lecture introduces the teams to a single question that must be answered in its future business plan. After the lecture, each team breaks away from the other teams and facilitator to brainstorm for approximately one hour to try to answer the question.

In most cases, it will be impossible to come up with a definitive answer to the question presented in an hour. The questions of each module will usually require a great deal of research and time to properly address. In addition, the answers reached in latter modules may affect the answers to questions presented earlier. It is important, however, that each team only spends the allotted amount of time during the working sessions on each question. Even though the members of the team may not have all the information or time needed to answer the question during the allotted time, the team should answer the question the best that they can and move on to the next module at the appropriate time.

Once the team answers a question, the answer is not set in stone. Rather, upon learning new facts or answering a later question in another module, the team may wish to adjust a previous answer. In the time between the working sessions, the team can perform research and put further thought into answering the questions.

This approach of addressing issues in a staged fashion forces each team to answer at least tentatively, many of the questions that need to be addressed in a business plan in a finite period of time. Otherwise, one can spend an infinite amount of time going in circles trying to resolve a few issues while never getting to others.

As an example, in one embodiment, the questions presented by the modules can be organized as follows:

Your Product: What have you got?
What is your technology?
Can you see your product?
How is the world surviving without it?

Your Customer: Who's going to care about this?
To whom will you (try) to sell?
Why will they care?

Your Competition: How does your product stack up?
What attributes are important to your customers?
What are the key risk areas?

Your Business Model: How will you operate?
What type of business do you envision?
What's the supply chain look like?

Market Potential: How big is this opportunity?
How large is the market?
What s your reasonable share?
What type of funding is appropriate?

Technology Status: What does the technology road look like?
What's already been accomplished?
What are the key steps to ‘finish the technology”?
Which of those steps involve the most risk?

Intellectual Property: How are we protected?
What patents relate to your technology?
Is there other intellectual property of value?

Economics: Can this idea make any money?
Who do you have to pay, who pays you?
What pricing strategy will you use?

Your Team: You and what army!?
Who is going to work on this idea?
How much time are they spending?
How will they be compensated?

Summary Assessment: Is the idea worth pursuing?

Notice that within each module there may be “sub-questions” which help the team answer the module's overall question. An alternative configuration of modules and questions is shown, below:

Our Product: What are we selling?
What is our technology?
Can we see our product?
How is the world possibly surviving without it?

Intellectual Property: Patents, know-how, and our image.
What patents relate to our technology?
Is there other intellectual property of value?
How professional do we look?

Technology Status: What's still left to complete?
What's already been accomplished?
What are the key steps to ‘finish” the technology?
Which of those steps involve the most risk?
Answer same questions for the “business”

Our Customer . . . and why they care!
To whom will we (try) to sell?
Why will they care?
What pain are we trying to solve?

Our Competition . . . and there's always competition
What attributes are important to our customers?
What are the pinch points going to be in trying to sell this?

Our Business Model: How will we operate?
How much are we going to bite off?
What's within our walls?
How will we get our product all the way to the end user
What value do we add along the way?

Economics: The money-flow behind the idea
Who do we have to pay; who pays us?
What's our pricing strategy?

Market Potential: Is this idea “right-sized”?
How large is the market?
What's our reasonable share?
What type of funding is appropriate?

Our Team: Before and after funding
Who will work on this before there's any funding?
How much time are they willing to spend?
How will they eventually be compensated for this?
What's our labor burn rate once funded?

Expenses: How will we budget our money?
How much will it cost to finish development?
How much will it cost to routinely operate?
   The latter configuration and phraseology may be more suited when there is only one team going through the pedagogy and the facilitator is actively serving as the mentor on the team.

Preferably, each team creates a slide for each module, visually answering the question presented. The facilitator provides a slide template for each module. Some modules can have multiple slides. Each team can present the slides created at the end of the 2^{nd} working session to the other teams and other entrepreneurs and professionals experienced with working with entrepreneurs and start up companies. The audience can provide constructive feed back to each of the teams in order to help them further solidify or “thicken” their business concepts. Preferably, the team's closing slides will comprise a loose outline of a business plan.

This concludes the description of the preferred embodiment of the invention. This description has been presented for purposes of illustration and description. It is not intended to be exhaustive or to limit the invention to the precise form disclosed. Many modifications and variations are possible in light of the above teaching. It is not intended that the scope of the invention will be limited by the foregoing description.

1. A method for assisting an entrepreneur in determining whether or not a business concept would produce a potentially viable business case, said method comprising the steps of:
a) establishing a plurality of main questions which need to be answered to produce said potentially viable business case;
b) forming a team of people to attempt to answer said questions;
c) conducting a workshop having a plurality of individual, sequentially occurring working modules equaling the number of said main questions, each working module having a predetermined time period during which said team attempts to answer the main question of the respective module; and
d) reviewing the answers generated in part c) to determine whether or not the business concept produces a potentially viable business case.

2. The method according to claim 1 wherein each of said working modules has a predetermined time period duration of about an hour.

3. The method according to claim 1 wherein said working modules in sum total between about 30 to about 40 hours in duration.

4. The method according to claim 1 wherein each of said working modules has a predetermined time period duration of about an hour and wherein said working modules in sum total between about 30 to about 40 hours in duration.

5. The method according to claim 1 wherein said team includes a startup mentor.

6. The method according to claim 1 wherein said team includes a person having expertise in finance.

7. The method according to claim 1 and further comprising the step of appointing a facilitator for administering said workshop.

8. The method according to claim 1 wherein a plurality of workshops having a respective plurality of teams are conducted simultaneously.

9. The method of claim 8 wherein six workshops are conducted simultaneously.

10. The method of claim 1 and further comprising the step of dividing at least one of said main questions into a plurality of sub-questions.

11. The method of claim 1 wherein the answer to a subsequently presented main question is used as an aid in refining the answering of a previously presented main question.
